(19) United States
(12) Patent Application Publication
(10) Pub. No.: US 2004/0181407 A1
(43) Pub. Date: Sep. 16, 2004

(54) Method and system for creating speech vocabularies in an automated manner

(75) Inventors: Marian Trinkel, Kreuzau-Untermaubach (DE); Christel Mueller, Schulzendorf (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Deutsche Telekom AG, Bonn (DE)

(21) Appl. No.: 10/797,382

(22) Filed: Mar. 10, 2004

(30) Foreign Application Priority Data
Mar. 10, 2003 (DE) DE 103 11 581.1

(51) Int. Cl. G10L 15/00

(52) U.S. Cl. 704/250

(57) ABSTRACT

A method for generating and/or expanding a vocabulary database of a voice recognition system includes acoustically training the voice recognition system using a computer-based audio module.

Priority is claimed to German patent application DE 103 11 581.1, the subject matter of which is hereby incorporated by reference herein.

The present invention relates generally to voice recognition systems, and in particular to a method for generating and/or expanding a vocabulary database of a voice recognition system by acoustic training of the voice recognition system. Moreover, the present invention relates to a voice recognition system having a vocabulary database.

### BACKGROUND

Voice recognition systems are generally known and are now used in various fields of application. In a departure from manual operation, a voice recognition system can be used, for example, to operate a data processing system, or any other machine, using voice commands.

There are also applications in the form of so-called “dictation programs”, in which the words spoken into a microphone by a user are analyzed, recognized, and converted into text data by a voice recognition system, thus allowing direct dictation of text into a word processor of a computer system.

The basis of any such voice recognition system is formed by a vocabulary database, which is used to compare a word spoken by a user with the stored vocabulary to be able to determine with high accuracy the word which was spoken by a user and which is to be converted into text accordingly.

Such a vocabulary database does not contain the words in the actual sense, but data/parameters which were determined from the spoken words and which are always dependent on the type of the recognition algorithm that is used as the basis for a voice recognition.

There are a number of known methods of voice recognition in use which, for example, are often based on the so-called “Hidden Markov Models”, or on “dynamic pattern matching” or “dynamic time warping”, where a word under analysis is compared to reference words stored in the vocabulary.

Frequently, the different options of voice recognition have in common that an obtained speech signal is subjected to acoustic pre-processing during which the words are divided into phonemes, that is, into the smallest units of speech. To this end, a functional analysis of the various possible sounds of a language is carried out.

In a first step of a voice recognition, it is possible, for example, to record short-time spectra of an acoustic signal which, directly or after data processing, are used as patterns in an analysis for comparison with reference patterns stored in a vocabulary database.

Thus, independently of the type of algorithm, there is always a need for a vocabulary database, i.e., the parameters thereof, which has a vocabulary structure typical of the algorithm used, and which is used to recognize spoken words. In this context, voice recognition programs or systems usually include a standard vocabulary database which already allows a high rate of recognition of the words spoken by a user.

However, frequently, a vocabulary database needs to be expanded for a new field of language, especially if technical terms are used which have previously not been available in the vocabulary database. In order to add such technical terms or, in general, new words to be learned to a voice recognition system, the voice recognition system is usually trained acoustically, meaning that the new words to be learned are spoken to the voice recognition system. By adding these new spoken words to the vocabulary database, the vocabulary database is continuously increased accordingly, allowing the voice recognition system to learn a new vocabulary.

In the prior art, it is known and common practice to generate or compile such vocabulary databases using a lot of manpower. To this end, the new words to be added are collected, processed, and spoken, for example, into an acoustic database through laborious human effort, the acoustic database then being used to acoustically train a voice recognition system in the known manner.

In this context, “acoustic training” does not only mean that new words to be learned are first converted into acoustic sound waves and then made available to a voice recognition system via a microphone input. During the acoustic training of a voice recognition system, sound conversion can, in principle, be omitted, and the acoustic data can immediately be made available to the voice recognition system in electronic form.

This is the case, for example, when a sound recording on tape is electronically fed into the microphone input of a voice recognition system without prior conversion to sound. Within the meaning of the present invention, this kind of training of a voice recognition system is also considered as “acoustic training”, because the training is based on acoustic signals even though they exist only in electronic form.

In the prior art, the high manpower requirements cause problems in the training process of the voice recognition system due to the great number of different persons because each person has a different voice pattern which does not match that of the person who will operate the system later.

Accordingly, the generation and expansion of a vocabulary database and the parameters thereof, as is known in the prior art, involves a lot of manual effort and manpower, so that such databases can only be created, compiled, and expanded at high cost.

### SUMMARY OF THE INVENTION

It is an object of the present invention is to provide a method and a system for generating and/or expanding a vocabulary database of a voice recognition system which allow the build-up of a vocabulary database or expansion of an existing vocabulary database in an inexpensive manner using little or no manpower.

The present invention provides a method for generating and/or expanding a vocabulary database of a voice recognition system by acoustic training of the voice recognition system. According to the invention, the voice recognition system is trained by a computer-based audio module.

According to the present invention, instead of using a person to train a voice recognition system, or using persons to create/expand the vocabulary database, the new words to be learned are spoken to the voice recognition system in an automated manner.

According to the present invention, it is proposed that this speech input of new words to be learned be carried out by a computer-based audio module. Accordingly, manpower requirements can be minimized here, allowing the vocabulary databases to be created in an extremely cost-effective and standardized manner using the method according to the present invention.

In the present invention, provision is preferably made to feed the audio module with vocabulary data which the audio module speaks to the voice recognition system in an automatic manner to expand the vocabulary database. As mentioned above, this speech input does not necessarily require the vocabulary data to be converted to sound via a loudspeaker system, and to then convert the sound into an electrical signal again using a microphone, but rather it is also possible here to avoid the sound conversion and to make the electrical acoustic signal immediately available to the voice recognition system.

In the method according to the present invention, the audio module may receive the vocabulary data from a speech database and/or via a telecommunications network. Especially if the vocabulary data is supplied via a telecommunications network, the data can, for example, be provided in the so-called “streaming mode”. This can be done, for example, via the Internet, for example, when radio programs are received via the Internet. Thus, for example, the technical vocabulary of a specific subject used in a radio program can be automatically taught to a voice recognition system by making the streaming data available to the audio module which then automatically speaks the speech data to the voice recognition system.

In an embodiment of the method according to the present invention, provision can be made to create the mentioned speech database through automated speech synthesis of text data in a speech synthesis unit. In the process, the text data can be extracted, for example, from a text database. Thus, arbitrary existing text databases can be drawn upon, and the text data stored therein can be converted to speech data using a speech synthesis unit. The speech data is then written to a speech database which, in turn, is made available to the voice recognition system for training, for which the speech data stored in the speech database is spoken to the voice recognition system, for example, via the audio module.

In another embodiment, the audio module of a voice recognition system can contain such a speech synthesis unit itself so that text data, especially from a text database, can be directly converted to speech data by the voice recognition system in order to use this data to carry out the training and to thereby expand the vocabulary database.

Here, artificial speech synthesis has the advantage that the vocabulary data is always spoken to the voice recognition system by a “standard” voice so that less problems occur during the acoustic training. In this context, provision can be made to select specific desired speech parameters or voice parameters, for example, with respect to the gender of the artificial voice, the age, body shape, dialect, etc., for the speech synthesis unit in order to adapt the voice recognition system as closely as possible to the person who will actually use it later.

Visual text data can be entered into the system automatically, for example, by scanning text images.

Besides the possibility of using existing text databases, the method according to the present invention can also be carried out by feeding the text data to the speech synthesis unit from an automatically created text database.

Such an automatically created text database can be generated automatically in the situation where, for example, vocabulary of a specific technical field is to be taught to voice recognition system. To this end, in the method according to the present invention, provision can be made that the text data which belongs to at least one text data source and which is found for at least one selected search term in an internal or external telecommunications network, in particular the Internet, using at least one search engine, be automatically stored in the text database.

It is known that, for example, in the Internet as a possible external communications network, a plurality of so-called “links” are found by entering a desired search term in a search engine; these links containing text data that is closely related to the entered search term. Thus, it is possible to very quickly and, above all, cost-effectively find significant, for example, statistically relevant, quantities of text data that are thematically related to the search term and made available to the voice recognition system for training within the scope of the method according to the present invention.

To this end, provision can be made for a data processing system or, possibly, the voice recognition system itself to automatically read the text data from the text data sources found, i.e., in the Internet, for example, at the linked addresses, and to store the text data in the text database. In this manner, a very large text database whose content is related to the search term is built up in an easy and fast manner.

Since this text data may also include data that is not intended to provide a contribution to the vocabulary database, such as common filler words or standard vocabulary, provision can be made for the text data in the text database to be analyzed and processed prior to speech synthesis. In addition to removing filler words, provision can also be made, for example, to delete multiple entries from the text database, or to create information regarding the frequency distribution of certain words; it being possible to integrate this information into the training process of the voice recognition system as well, just as information about the probabilities with which certain text data items are related to each other.

For example, it is known to perform a so-called “context check” during voice recognition, the context check being used to determine the probability with which a found word is followed by another word in order to make an appropriate selection from a number of possible alternatives. This is done, for example, to avoid problems with homophones, that is, with words that sound alike but are different in meaning.

According to the present invention, such information, for example, about context probabilities, or any other type of additional information, can be obtained from the acquired text data prior to performing speech synthesis, and additionally made available to a voice recognition system.

The present invention also provides a voice recognition system including a vocabulary database and a speech synthesis unit which can be fed with text data from a text database by acoustic speech input in order to generate and/or expand the vocabulary database. The text database is generated according to the present invention by automatically searching a telecommunications network for text data related to a selected search term.

### BRIEF DESCRIPTION OF THE DRAWINGS

An exemplary embodiment of the present invention is illustrated in more detail in the following drawings, in which:

FIG. 1 shows a schematic representation of a voice recognition system with a connection to the Internet; and

FIG. 2 shows a more detailed schematic representation of a voice recognition system.

### DETAILED DESCRIPTION

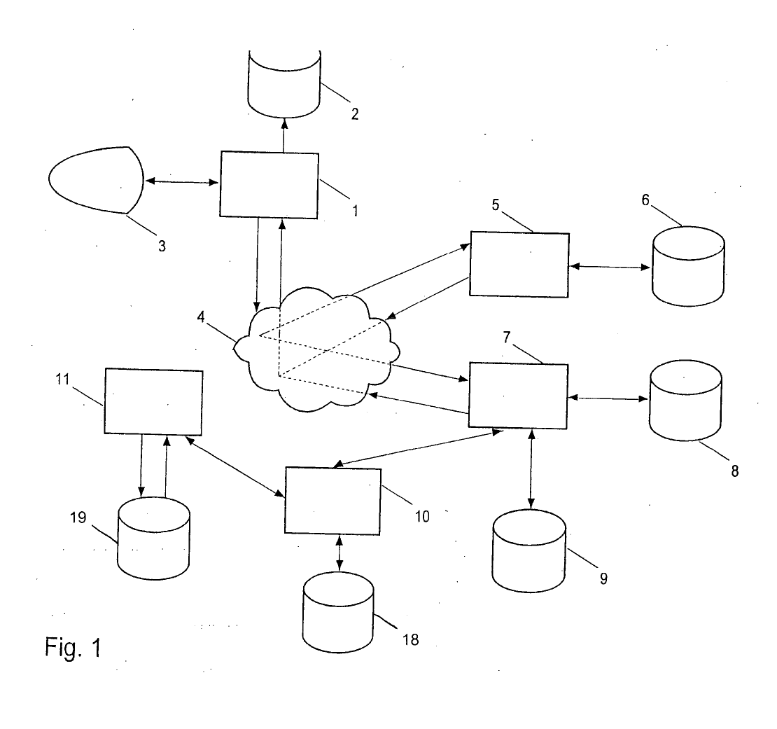

FIG. 1 shows a voice recognition system 1 which has access to a vocabulary database 2 and is operated by a user 3. Such a system can be composed, for example, of a home PC with a dictation program.

Besides the possibility of voice recognition, for example, within the scope of a dictation function of a word processing program, which is not further explained here, the voice recognition system 1 according to the present invention is connected to the Internet 4 via suitable telecommunications lines.

If a user 3 wishes to expand the speech vocabulary in vocabulary database 2, for example, by a specific technical vocabulary, then user 3 can enter into the voice recognition system, for example, via a computer terminal a search term that is characteristic of the relevant new field to be learned. Using the voice recognition system 1 according to the present invention, for example, a first search engine 5 is accessed via the Internet 4, and the search term is entered into the search engine whereupon search engine 5 searches the Internet and/or an associated database 6 for text data and/or hypertext data containing the search term, after which this text data is in turn made available to the voice recognition system via the Internet.

In this context, provision can also be made for voice recognition system 1 to initially instruct, via the Internet, a central search engine 7 to look for the desired term, which central search engine in turn has access to a plurality of databases 8 and 9 and which, moreover, instructs additional distributed search engines 10 and 11 to also search their associated respective databases 18 and 19 for the search term. Thus, the voice recognition system can also submit a request to a search engine which, in turn, distributes the search to additional search engines.

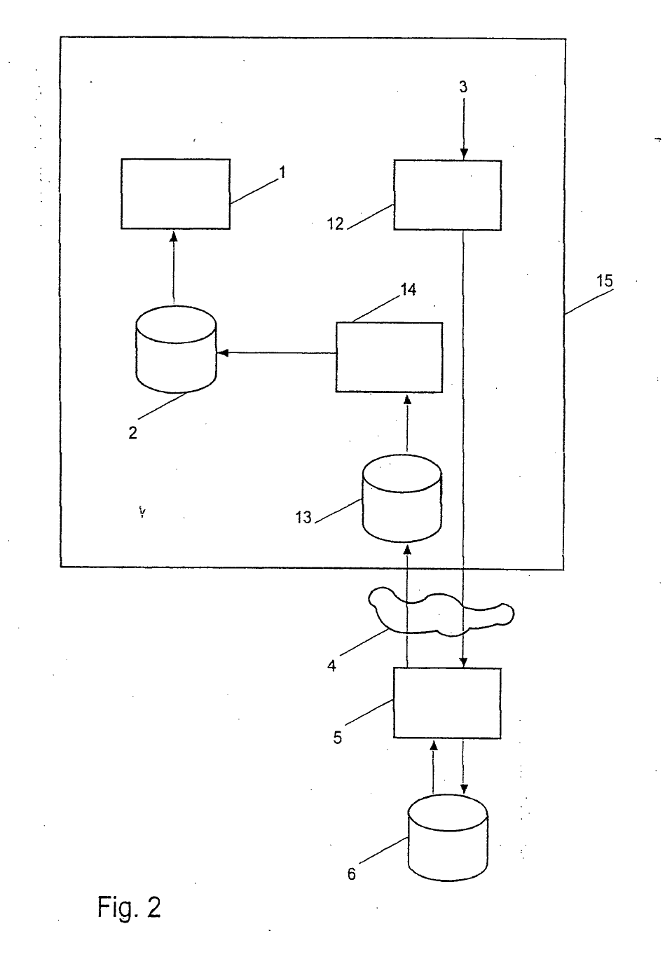

The total quantities of obtained text data can be collected in a distributed manner, or centrally in the voice recognition system, and drawn upon to train the voice recognition system via a speech synthesis unit, possibly after preprocessing. This procedure is further illustrated in FIG. 2.

According to FIG. 2, a user 3 can use a computer system 12 to submit a search request, for example, via a telecommunications line into the Internet 4, to one or more search engines 5 having access, for example, to databases 6.

According to the method of the present invention, the text sources found, which, in the Internet environment, are referred to as “links”, are, for example, preferably polled by computer system 12 in an automatic manner so that the text data contained therein can be collected and transferred to a text database 13 where this text data is collected and edited, if necessary, for example, to delete filler words, to eliminate multiple entries, and possibly to establish contextual relationships.

The collected text data maintained in text database 13 can then be fed to a speech synthesis unit 14, whereby the text data is converted to speech data and stored in database 2.

This speech conversion is followed by the actual learning phase, that is, the speech data from database 2 is spoken to voice recognition system 1 internally, possibly without sound conversion in a purely electronic way, thus expanding an internal database of voice recognition system 1.

The individual elements 1, 12, 13, 14 and 2 can also be combined into a module 15.

The method according to the present invention provides a cost-effective way to expand an existing vocabulary database of a voice recognition system or to generate a new vocabulary database to be built up by automatically drawing upon a wealth of text data of the relevant databases. The present invention also provides a voice recognition system including a speech synthesis unit speaking the text data to carry out the learning process.

What is claimed is:

1. A method for generating and/or expanding a vocabulary database of a voice recognition system, comprising:
providing a computer-based audio module; and
training the voice recognition system by acoustic training using the audio module.

2. The method as recited in claim 1 wherein the training the voice recognition system is performed by:
providing the audio module with vocabulary data; and
speaking the vocabulary data to the voice recognition system in an automated manner using the audio module so as to expand the vocabulary database.

3. The method as recited in claim 1 wherein the training the voice recognition system is performed by providing the audio module with vocabulary data from a speech database.

4. The method as recited in claim 1 wherein the training the voice recognition system is performed by providing the audio module with vocabulary data via a telecommunications network.

5. The method as recited in claim 3 wherein the providing the audio module with vocabulary data is performed in a streaming mode.

6. The method as recited in claim 4 wherein the providing the audio module with vocabulary data is performed in a streaming mode.

7. The method as recited in claim 3 further comprising creating the speech database by automated speech synthesis of text data using a speech synthesis unit.

8. The method as recited in claim 7 further comprising providing the text data from a text database.

9. The method as recited in claim 1 wherein the audio module includes a speech synthesis unit which converts text data to speech data.

10. The method as recited in claim 9 further comprising providing the text data from a text database.

11. The method as recited in claim 9 further comprising:
creating a text database in an automatic manner; and
providing the text data to the speech synthesis unit from the text database..

12. The method as recited in claim 11 wherein the creating the text database is performed by:
finding the text data in an internal or external telecommunications network using at least one search engine, the text data being associated with at least one search term;
receiving the text data from at least one text data source; and
automatically storing the text data in the text database.

13. The method as recited in claim 12 wherein the telecommunications network includes the Internet.

14. The method as recited in claim 12 wherein the creating the text database is performed by automatically reading the text data from the at least one text data source using a data processing system and wherein the automatically storing is performed using the data processing system.

15. The method as recited in claim 1 wherein the training the voice recognition system is performed by providing the audio module with vocabulary data from a speech database and further comprising:
creating the speech database by automated speech synthesis of text data from a text database using a speech synthesis unit; and analyzing and processing the text data prior to the speech synthesis.

16. A voice recognition system comprising:
a vocabulary database;
a text database; and
a speech synthesis unit capable of receiving text data from the text database by acoustic speech input so as to generate and/or expand the vocabulary database.

17. The voice recognition system as recited in claim 16 wherein the text database is generated by automatically searching a telecommunications network for text data related to a selected search term.
